(19) United States
(12) Patent Application Publication
(10) Pub. No.: US 2011/0199908 A1
(43) Pub. Date: Aug. 18, 2011

(54) Methods and Apparatuses for Measurement Gap Pattern for Carrier Aggregation

(75) Inventors: Lars Dalsgaard, Oulu (FI); Jarkko Tuomo Koskela, Oulu (FI); Jorma Johannes Kaikkonen, Oulu (FI); Tero Heikki Matti Henttonen, Espoo (FI)

(73) Assignee: NOKIA CORPORATION, Espoo (FI)

(21) Appl. No.: 12/705,887

(22) Filed: Feb. 15, 2010

(51) Int. Cl. H04L 12/26; H04W 24/00; H04W 72/04

(52) U.S. Cl. 370/241; 370/329

(57) ABSTRACT

In accordance with an example embodiment of the present invention, a method comprises retuning a receiver of a user equipment (UE) to a first bandwidth at a first mini gap of a gap pattern wherein the first bandwidth covers at least one active component carrier and at least one inactive component carrier; taking measurements of the at least one inactive component carrier; and retuning the receiver to a second bandwidth at a second mini gap of the gap pattern wherein the second bandwidth covers at least the one active component carrier, and wherein a length of the first mini gap and a second length of the second mini gap are short and independent of a duration for taking the measurements.

### TECHNICAL FIELD

The present application relates generally to method and apparatuses for measurements gap pattern for carrier aggregation.

### BACKGROUND

Aggregation of multiple component carriers for wireless system, which is also termed carrier aggregation (CA), may provide wireless devices with flexible and expanded bandwidth to meet the bandwidth demands of new applications with large amount of data. A component carrier is a flexibly allocated bandwidth that may be allocated to a network device such as a user equipment (UE) in addition to an existing allocated resource. Multiple component carriers may be aggregated on demand or statically for the UE.

Aggregated component carriers may need to be measured from time to time by the UE and the collected measurements reported to an associated network node for various purposes such as network maintenance and resource allocation. Some of the component carriers may be actively carrying traffic and some may be in an inactive state, not carrying any data traffic. For measurement purpose, both active and inactive component carriers need to be measured.

### SUMMARY

Various aspects of examples of the invention are set out in the claims.

According to a first aspect of the present invention, a method comprises retuning a receiver of a user equipment (UE) to a first bandwidth at a first mini gap of a gap pattern wherein the first bandwidth covers at least one active component carrier and at least one inactive component carrier; taking measurements of the at least one inactive component carrier; and retuning the receiver to a second bandwidth at a second mini gap of the gap pattern wherein the second bandwidth covers at least the one active component carrier, and wherein a length of the first mini gap and a second length of the second mini gap are short and independent of a duration for taking the measurements.

According to a third aspect of the present invention, an apparatus comprises a carrier aggregation (CA) control module configured to cause to retune a receiver of the apparatus to a first bandwidth at a first mini gap of a gap pattern wherein the first bandwidth covers at least one active component carrier and at least one inactive component carrier; and retune the receiver to a second bandwidth at a second mini gap of the gap pattern wherein the second bandwidth covers at least the one active component carrier, and wherein a length of the first mini gap and a second length of the second mini gap are short and independent of a duration for taking the measurements; and a measurement module configured to take measurements of the at least one inactive component carrier.

According to a second aspect of the present invention, an apparatus comprises at least one processor; and at least one memory including computer program code the at least one memory and the computer program code configured to, with the at least one processor, cause the apparatus to perform at least the following: retuning a receiver to a first bandwidth at a first mini gap of a gap pattern wherein the first bandwidth covers at least one active component carrier and at least one inactive component carrier; taking measurements of the at least one inactive component carrier; and retuning the receiver to a second bandwidth at a second mini gap of the gap pattern wherein the second bandwidth covers at least the one active component carrier, and wherein a length of the first mini gap and a second length of the second mini gap are equally short and independent of a duration of taking the measurements.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example wireless system in accordance with an example embodiment of the invention.

FIG. 2 illustrates an example method for measurement gap pattern for carrier aggregation in accordance with an example embodiment of the invention;

FIG. 3a illustrates an example carrier aggregation with mini gaps for measurements in accordance with an example embodiment of the invention;

FIG. 3b illustrates an example carrier aggregation with mini gaps for measurements for hybrid automatic repeat request (HARQ) operation in accordance with an example embodiment of the invention;

FIG. 3c illustrates an example gap pattern periodicity in accordance with an example embodiment of the invention;

FIG. 4 illustrates an example apparatus for implementing a gap pattern for carrier aggregation in accordance with an example embodiment of the invention; and

FIG. 5 illustrates an example wireless apparatus in accordance with an example embodiment of the invention.

### DETAILED DESCRIPTION OF THE DRAWINGS

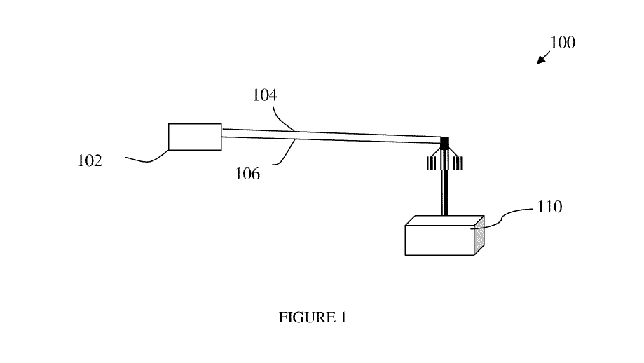

An example embodiment of the present invention and its potential advantages are understood by referring to FIGS. 1 through 5 of the drawings.

FIG. 1 illustrates an example wireless system 100 in accordance with an example embodiment of the invention. The wireless 100 comprises a user equipment (UE) such as a mobile station 102, and a base station such as long-term evolution-advance (LTE-A) evolution node B (eNodeB) 110. The UE 102 is connected to the eNodeB via a component carrier 104 and a second component carrier 106 that are aggregated to support higher bandwidth application. In this case, the two component carriers 104 and 106 are contiguous or intra-band component carriers, meaning that they share the same radio frequency chain.

In one example embodiment, the component carrier 104 is active, carrying a voice or data call traffic and the component is in an active state. The component carrier 106 is inactive, not carrying live traffic. The UE 102 may still take measurements of both the component carriers 104 and 106, and report the measurements to the eNodeB 110 for various purposes such as maintenance and resource allocation. Instead of listening to both the component carriers 104 and 106 continuously and taking measurements, which may be power consuming to the UE 102, the UE 102 may have a gap pattern that directs the UE 102 to measure the inactive component carrier at a designated point. The gap pattern may have two mini gaps, and two switching points each associated with one of the two mini gaps to mark the beginning of the associated mini gap. At the first switching point, the UE 102 retunes its receiver to a wide bandwidth that covers both the component carriers 104 and 106. The mini gap is short, and sufficient for the device 102 to retune its radio frequency to start listening to the wide bandwidth. Because the mini gap is very short, the impact of the interruption on the data traffic is minimal. Once the measurements on at least the inactive component carrier 106 are taken during the gap period, at second mini gap, the UE 102 retunes its receiver back to the original narrower bandwidth covering the active component carrier 104 for regular data transmission and reception. Again, the second mini gap is short because it only needs to be sufficient to retune the RF receiver.

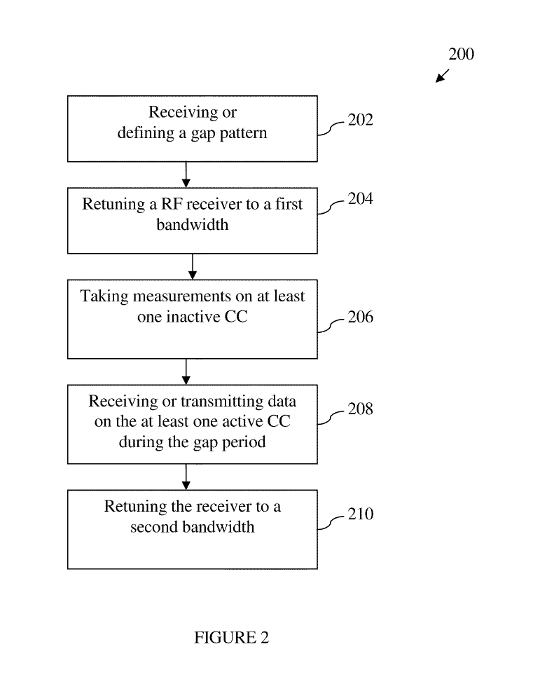

FIG. 2 illustrates an example method 200 for measurement gap pattern for carrier aggregation in accordance with an example embodiment of the invention. The method 200 includes receiving or defining a gap pattern at block 202, retuning a RF receiver at 204, and taking measurements on at least one inactive component carrier at block 206. The method 200 also includes potentially receiving or transmitting data on the at least one active component carrier during the gap period at block 208 and retuning the RF receiver to a second bandwidth at block 210.

In one example embodiment, receiving the gap pattern at block 202 may include receiving a gap pattern from an associated network node such as the eNodeB 110 of FIG. 1. The gap pattern may include a pairs of mini gaps, a pair of switching points associated with the pairs of the mini gaps, and a gap period that is the time period between the two mini gaps and may be configurable if there is a need. The network node may send the gap pattern along with other resource allocations or grants, using an existing protocol such as radio resource control (RRC) protocol. Since the network node has an overall view of resource allocation for the UE, the network node may schedule the gap pattern in such a way that the mini gaps may avoid interrupting time sensitive traffic. One way for the network node to schedule the gap pattern is to follow a set of rules that are described below.

In another example embodiment, alternatively defining the gap pattern at block 202 may include defining the gap pattern locally at the UE such as the mobile station 102 of FIG. 1. Because the UE may not have an overall view of resource allocations, a set of rules may be used to define the gap pattern. The rules impose constraints on the gap patterns. For example, one rule may be that two consecutive mini gaps may not be in a same HARQ process to minimize the impact on the HARQ process. Another rule may be that a gap pattern periodicity is defined in such a way that two consecutive gap patterns are spaced with at least a predetermined amount of time in between. Another rule may be that the gap pattern is scheduled in such a way that the pair of mini gaps does not interrupt one or more designated HARQ process or the number of mini gap pairs for a given period of time is limited to a predetermined limit. These rules may also be implemented by the network node in scheduling the gap pattern for the UE.

In another example embodiment, defining the gap pattern at block 202 may also include determining the gap period between the pair of mini gaps. The gap period should be sufficient for the UE to take measurements of at least the inactive component carriers. Defining the gap pattern at block 202 may also include determining the lengths of the mini gap pair. The lengths of the mini gap pair may be same or different and may be configurable, depending on the application need or UE capability. The UE may optionally notify the associated network node of its gap pattern so that the network node may take into consideration the gap pattern defined by the UE in allocating and scheduling the resource.

In one example embodiment, retuning the RF receiver at 204 may include tuning its RF receiver to a wide bandwidth that covers all active and inactive component carriers so that the receiver may listen to all the component carriers for the measurements. Before the retuning, the UE may be in a regular traffic mode, transmitting or receiving data on at least one active component carrier. Retuning the RF receiver at 204 may be triggered at the first switching point of the first mini gap of the gap pattern and may take only very short period of time, such as 1 ms.

In one example embodiment, taking measurements on at least one inactive component carrier at block 206 may include listening to all inactive component carriers to be measured and take measurements of the radio signal strength and other parameters. Optionally, taking measurements at block 206 may also include taking measure on at least one active component carrier which may be carrying active traffic data. Take measurements at block 206 may also include complying with a specified level of accuracy of the measurements and sending the collected measurements to the associated network node such as eNodeB 110 of FIG. 1.

In one example embodiment, receiving or transmitting data during the gap period at block 208 may include transmitting traffic data on the at least one active component carrier while taking measurements. The normal traffic may still be carried on the active component carrier during the gap period while the measurements are taken.

In one example embodiment, retuning the RF receiver to a second bandwidth at block 210 may include tuning the RF receiver back to a narrow bandwidth covering the at least one active component carrier. The retuning is triggered by the second switching point of the second mini gap and is completed during the second mini gap which as a non-limiting example is very short such as 1 ms.

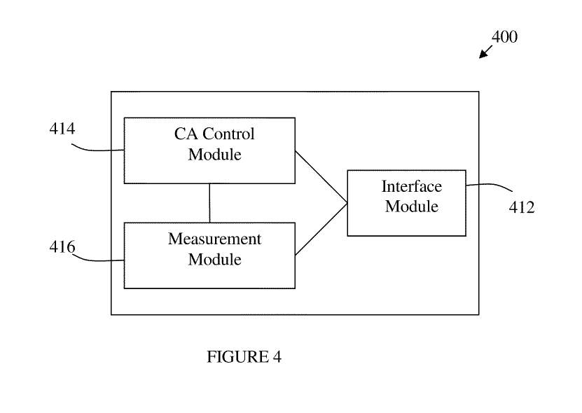

In one example embodiment, the method 200 may be implemented in the UE 102 of FIG. 1 or by the apparatus 400 of FIG. 4. The method 200 is for illustration only and the steps of the method 200 may be combined, divided, or executed in a different order than illustrated, without departing from the scope of the invention of this example embodiment.

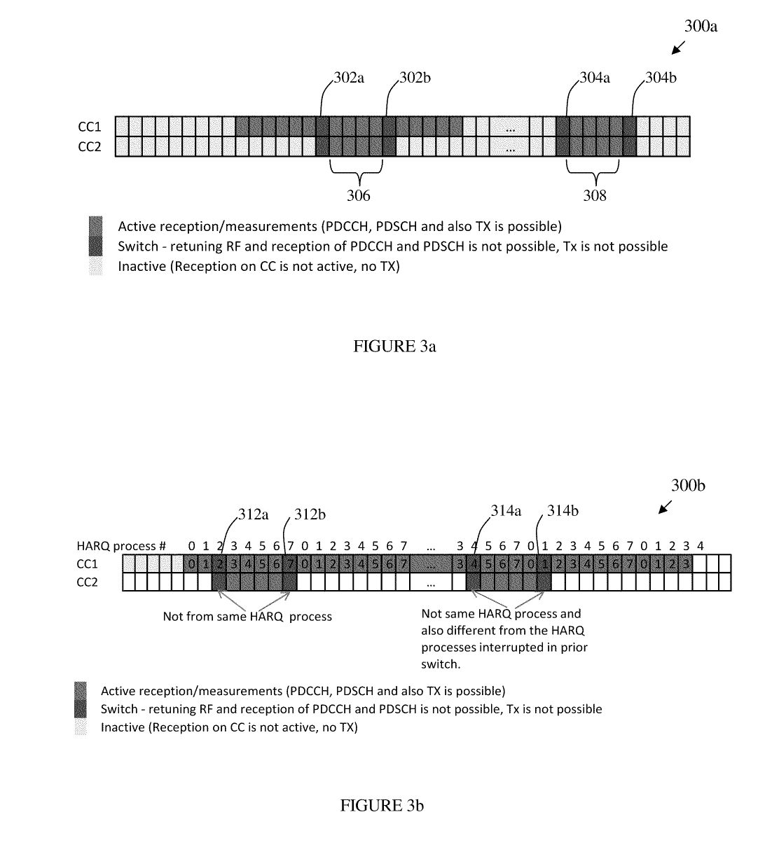

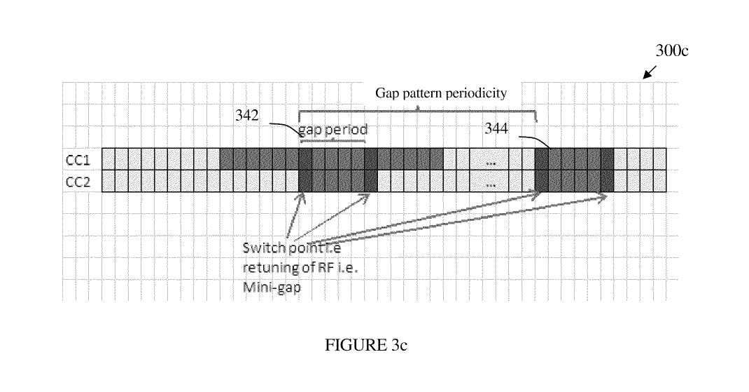

FIG. 3a illustrates an example carrier aggregation 300a with mini gaps for measurements in accordance with an example embodiment of the invention. The example carrier aggregation 300a includes two component carriers, CC1 and CC2, while CC1 is an active component carrier and CC2 is an inactive component carrier. The first gap pattern includes a pair of mini gaps 302a and 302b, and a gap period 306. The two switching points of the gap pattern are the starting point of two mini gaps 302a and 302b. During the gap period, reception of physical down link control channel and physical downlink shared channel may take place along with the measurements of either the inactive component carrier CC2 or both the active component carrier CC1 and inactive component carrier CC2. Transmission on uplink channels may also take place during the gap period. The second gap pattern may be scheduled a certain period after the first gap pattern and the second gap pattern includes a pair of mini gaps 304a and 304b and a gap period 308.

FIG. 3b illustrates an example carrier aggregation 300b with mini gaps for measurements during a hybrid automatic repeat request (HARQ) operation in accordance with an example embodiment of the invention. The carrier aggregation includes an active component carrier CC1 and an inactive component carrier CC2. There are eight HARQ processes executing on the active component carrier CC1. The gap pattern is scheduled in such a way that the pair of mini gaps 312a and 312b are in the HARQ process 2 and the HARQ process 7 respectively, avoiding being in the same HARQ process to minimize the potential impact on the HARQ operation. Similarly, the pair of mini gaps 314a and 314b of the second gap pattern is scheduled in two different HARQ processes, the HARQ process 4 and the HARQ process 1 respectively, to minimize the impact of measurements on the HARQ operations. However, in some cases, mini gaps may be scheduled within the same HARQ process if there is a need.

FIG. 3c illustrates an example gap pattern periodicity 300c in accordance with an example embodiment of the invention. The gap pattern periodicity 300c shows a first gap pattern 342 and a second gap pattern 344. The gap pattern periodicity covers the period from the beginning of the first gap pattern 342 to the beginning of the second gap pattern 344. In one example embodiment, the gap pattern periodicity may be determined based on one or more factors such as a current discontinuous reception, a serving cell threshold, and a transmission time interval.

FIG. 4 illustrates an example apparatus 400 for implementing a gap pattern for carrier aggregation in accordance with an example embodiment of the invention. The apparatus 400 includes a carrier aggregation (CA) control module 414, a measurement module 416 and an interface module 412.

In one example embodiment, the interface module 412 may be configured to receive the gap pattern from an associated network node. The measurement module 416 may be configured to take measurements of the at least one inactive component carrier. Optionally, the measurement module 416 may be configured to take measurements of the at least one active component carrier at the same time. The measurement module 416 may be configured to define the gap pattern periodicity based on at least one of a current discontinuous reception, a serving cell threshold, and a transmission time interval. The measurement module 416 may be further configured to define the gap pattern based on at least one of following rules: disallowing consecutive measurement gap patterns in a same HARQ process, spacing two consecutive gap patterns with at least a predetermined amount of time in between; and scheduling the gap pattern in such a way that the gap pattern does not interrupt one or more designated HARQ process.

The CA control module 414 may be configured to retune a receiver of the apparatus to a first bandwidth at a first mini gap of a gap pattern wherein the first bandwidth covers at least one active component carrier and at least one inactive component carrier during a hybrid automatic repeat request (HARQ) operation. The CA control module 414 may also be configured to retune the receiver to a second bandwidth at a second mini gap of the gap pattern wherein the second bandwidth covers at least the one active component carrier, and wherein a length of the first mini gap and a second length of the second mini gap are equally short and independent of a duration of taking the measurements.

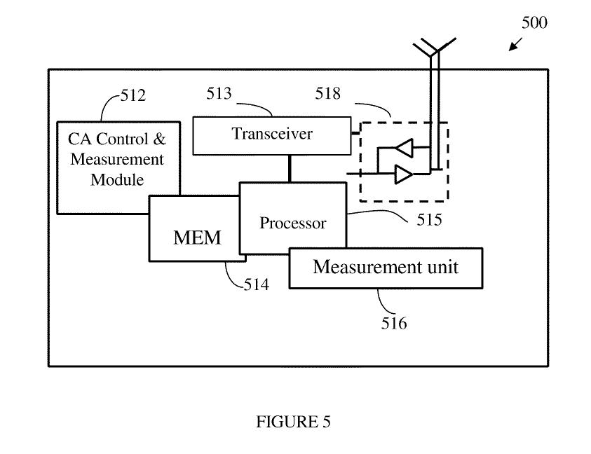

FIG. 5 illustrates an example wireless apparatus 500 in accordance with an example embodiment of the invention. The wireless apparatus 500 may include a processor 515, a memory 514 coupled to the processor 515, and a suitable transceiver 513 (having a transmitter (TX) and a receiver (RX)) coupled to the processor 515, coupled to an antenna unit 518. The memory 514 may store programs such as a carrier aggregation control and measurement module 512.

In an example embodiment, the processor 515 or some other form of generic central processing unit (CPU) or special-purpose processor such as digital signal processor (DSP), may operate to control the various components of the wireless apparatus 500 in accordance with embedded software or firmware stored in memory 514 or stored in memory contained within the processor 515 itself. In addition to the embedded software or firmware, the processor 515 may execute other applications or application modules stored in the memory 514 or made available via wireless network communications. The application software may comprise a compiled set of machine-readable instructions that configures the processor 515 to provide the desired functionality, or the application software may be high-level software instructions to be processed by an interpreter or compiler to indirectly configure the processor 515. In an example embodiment, the mapping 512 may be configured to allocate one or more additional component carriers to a user equipment when a need arises and the resources are available in collaboration with other modules such as the transceiver 513.

In an example embodiment, the carrier aggregation control and measurement module 512 may be configured to retune a receiver to a first bandwidth at a first mini gap of a gap pattern wherein the first bandwidth covers at least one active component carrier and at least one inactive component carrier. The carrier aggregation control and measurement module 512 may be configured to take measurements of the at least one active component carrier and optionally take measurements of the at least one inactive component carrier, and retune the receiver to a second bandwidth at a second mini gap of the gap pattern wherein the second bandwidth covers at least the one active component carrier. The length of the first mini gap and a second length of the second mini gap are equally short and independent of a duration of taking the measurements.

In one example embodiment, the transceiver 513 is for bidirectional wireless communications with another wireless device. The transceiver 513 may provide frequency shifting, converting received RF signals to baseband and converting baseband transmit signals to RF, for example. In some descriptions a radio transceiver or RF transceiver may be understood to include other signal processing functionality such as modulation/demodulation, coding/decoding, interleaving/deinterleaving, spreading/despreading, inverse fast fourier transforming (IFFT)/fast fourier transforming (FFT), cyclic prefix appending/removal, and other signal processing functions. In some embodiments, the transceiver 513, portions of the antenna unit 518, and an analog baseband processing unit may be combined in one or more processing units and/or application specific integrated circuits (ASICs). Parts of the transceiver may be implemented in a field-programmable gate array (FPGA) or reprogrammable software-defined radio.

In one example embodiment, the transceiver 513 may include a filtering apparatus for non-centered component carriers such as the filtering apparatus 300. As such, the filtering apparatus may include a processor of its own and at least one memory including computer program code. The at least one memory and the computer program code configured to, with the processor, cause the filtering apparatus to perform at least the following: converting a first frequency signal into a second frequency signal based at least in part on a first complex-valued local oscillator signal; filtering the second frequency signal; and converting the filtered second frequency signal into a third frequency signal based at least in part on a second complex-valued local oscillator signal wherein the third frequency signal shares a frequency position with the first frequency signal and the first complex-valued local oscillator signal and the second complex-valued local oscillator signal indicate allocations of transmitted channels.

In an example embodiment, the antenna unit 518 may be provided to convert between wireless signals and electrical signals, enabling the wireless apparatus 500 to send and receive information from a cellular network or some other available wireless communications network or from a peer wireless device. In an embodiment, the antenna unit 518 may include multiple antennas to support beam forming and/or multiple input multiple output (MIMO) operations. As is known to those skilled in the art, MIMO operations may provide spatial diversity and multiple parallel channels which can be used to overcome difficult channel conditions and/or increase channel throughput. The antenna unit 518 may include antenna tuning and/or impedance matching components, RF power amplifiers, and/or low noise amplifiers.

As shown in FIG. 5, the wireless apparatus 500 may further include a measurement unit 516, which measures the signal strength level that is received from another wireless device, and compare the measurements with a configured threshold. The measurement unit may be utilized by the wireless apparatus 500 in conjunction with various exemplary embodiments of the invention, as described herein.

In general, the various exemplary embodiments of the wireless apparatus 500 may include, but are not limited to, part of a user equipment, or a wireless device such as a portable computer having wireless communication capabilities, Internet appliances permitting wireless Internet access and browsing, as well as portable units or terminals that incorporate combinations of such functions.

Without in any way limiting the scope, interpretation, or application of the claims appearing below, a technical effect is less power consumption by a UE via specifying when the UE is allowed to change reception bandwidth for performing mobility measurements. Another technical effect is to allow the UE to utilize only part of the RF chain to achieve some power consumption gains in a situation where the carrier components are contiguous but not all these component carriers are active.

Embodiments of the present invention may be implemented in software, hardware, application logic or a combination of software, hardware and application logic. The software, application logic and/or hardware may reside on a base station or an access point. If desired, part of the software, application logic and/or hardware may reside on access point, part of the software, application logic and/or hardware may reside on a network element such as a LTE eNodeB and part of the software, application logic and/or hardware may reside on mobile station. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 5. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A method, comprising:
retuning a receiver of a user equipment (UE) to a first bandwidth at a first mini gap of a gap pattern wherein the first bandwidth covers at least one active component carrier and at least one inactive component carrier;
taking measurements of the at least one inactive component carrier; and
retuning the receiver to a second bandwidth at a second mini gap of the gap pattern wherein the second bandwidth covers at least the one active component carrier, and wherein a length of the first mini gap and a second length of the second mini gap are short and independent of a duration for taking the measurements.

2. The method of claim 1, further comprising receiving the gap pattern from an associated network node or defining the gap pattern at the UE.

3. The method of claim 2 wherein the gap pattern comprises at least the first mini gap, the second mini gap and a gap period between the first mini gap and the second mini gap.

4. The method of claim 3 wherein defining the gap pattern at the UE comprises disallowing consecutive mini gaps in a same hybrid automatic repeat request (HARQ) process during a HARQ operation.

5. The method of claim 3 wherein defining the gap pattern at the UE comprises defining a gap pattern periodicity in such a way that two consecutive gap patterns are spaced with at least a predetermined amount of time in between.

6. The method of claim 3 wherein defining the gap pattern at the UE comprises scheduling the gap pattern in such a way that the pair of mini gaps of the gap pattern does not interrupt one or more designated HARQ processes.

7. The method of claim 3 where the received gap pattern is based on at least one of following rules:
disallowing consecutive mini gaps in a same HARQ process during a HARQ operation;
defining a gap pattern periodicity in such a way that two consecutive gap patterns are spaced with at least a predetermined amount of time in between; and
scheduling the gap pattern in such a way that the pair of mini gaps do not interrupt one or more designated HARQ processes.

8. The method of claim 7 wherein the gap pattern periodicity is determined based on at least one of a current discontinuous reception, a serving cell threshold, and a transmission timec interval.

9. The method of claim 3, further comprising receiving or transmitting data on the at least one active component carrier during the gap period.

10. The method of claim 1, further comprising taking measurements of the at least one active component carrier.

11. The method of claim 10, further comprising collecting the measurements on the at least one active component carrier and the at least inactive component carrier and sending the collected measurements to an associated network node.

12. An apparatus, comprising:
a carrier aggregation (CA) control module configured to cause to
retune a receiver of the apparatus to a first bandwidth at a first mini gap of a gap pattern wherein the first bandwidth covers at least one active component carrier and at least one inactive component carrier; and
retune the receiver to a second bandwidth at a second mini gap of the gap pattern wherein the second bandwidth covers at least the one active component carrier, and wherein a length of the first mini gap and a second length of the second mini gap are short and independent of a duration for taking measurements of the at least one inactive component carrier; and
a measurement module configured to
take measurements of the at least one inactive component carrier.

13. The apparatus of claim 12, further comprising an interface module configured to receive the gap pattern from an associated network node wherein the received gap pattern is based on at least one of following rules:
disallowing consecutive mini gaps in a same hybrid automatic repeat request (HARQ) process during a HARQ operation;
defining a gap pattern periodicity in such a way that two consecutive gap patterns are spaced with at least a predetermined amount of time in between; and
scheduling the gap pattern in such a way that the pair of mini gaps do not interrupt one or more designated HARQ process.

14. The apparatus of claim 12 wherein the gap pattern comprises at least the first mini gap, the second mini gap and a gap period between the first mini gap and the second mini gap, wherein the gap period is configurable.

15. The apparatus of claim 14 wherein the length of the gap period is sufficient for the measurement module to take the measurements of the at least one inactive component carrier.

16. The apparatus of claim 12 wherein the measurement module is configured to define the gap pattern based on at least one of following rules:
disallowing consecutive mini gaps in a same HARQ process during a HARQ operation;
defining a gap pattern periodicity in such a way that two consecutive gap patterns are spaced with at least a predetermined amount of time in between; and
scheduling the gap pattern in such a way that the pair of mini gaps do not interrupt one or more designated HARQ process.

17. The apparatus of claim 12, wherein a length of the first mini gap and a second length of the second mini gap are short and sufficient to retune the receiver to either the first bandwidth or the second bandwidth.

18. The apparatus of claim 12 wherein the at least one active component carrier is one of a downlink component carrier and an uplink component carrier and wherein the at least one active component carrier and the at least inactive component carrier share a same radio frequency chain.

19. An apparatus, comprising:
at least one processor; and
at least one memory including computer program code
the at least one memory and the computer program code configured to, with the at least one processor, cause the apparatus to perform at least the following:
retuning a receiver to a first bandwidth at a first mini gap of a gap pattern wherein the first bandwidth covers at least one active component carrier and at least one inactive component carrier;
taking measurements of the at least one inactive component carrier; and
retuning the receiver to a second bandwidth at a second mini gap of the gap pattern wherein the second bandwidth covers at least the one active component carrier, and wherein a length of the first mini gap and a second length of the second mini gap are equally short and independent of a duration of taking the measurements.

20. The apparatus of claim 19 wherein the at least one memory and the computer program code is configured to, with the at least one processor, to further cause the apparatus to receive from an associated network node or define the gap pattern at the apparatus wherein the gap pattern comprises at least the first mini gap, the second mini gap and a gap period between the first mini gap and the second mini gap and wherein the gap pattern is based on at least one of following rules:
disallowing the pair of mini gaps in a same hybrid automatic repeat request (HARQ) process during a HARQ operation;
defining a gap pattern periodicity in such a way that two consecutive gap patterns are spaced with at least a predetermined amount of time in between; and
scheduling the gap pattern in such a way that the pair of mini gaps do not interrupt one or more designated HARQ processes.
